(19) United States
(12) Patent Application Publication
(10) Pub. No.: US 2004/0198900 A1
(43) Pub. Date: Oct. 7, 2004

(54) Two part polyurethane sealant composition with low modulus and good paintability

(75) Inventor: Edmund J. Madaj, Prior Lake, MN (US)

Correspondence Address: JOSEPH G CURATOLO, ESQ., RENNER KENNER GREIVE BOBAK TAYLOR & WEBER, 24500 CENTER RIDGE ROAD, SUITE 280, WESTLAKE, OH, 44145, US

(73) Assignee: Construction Research & Technology GmbH, Trostberg (DE)

(21) Appl. No.: 10/797,548

(22) Filed: Mar. 10, 2004

Related U.S. Application Data
(60) Provisional application No. 60/460,741, filed on Apr. 4, 2003.

(51) Int. Cl. C08K 3/00

(52) U.S. Cl. 524/589

(57) ABSTRACT

A polyurethane sealant is the reaction product of a hydroxy-terminated toluenediisocyanate/polyoxyalkylene polyol prepolymer component, an isocyanate-terminated toluenediisocyanate/polyoxyalkylene polyol activator component, and at least one of a diphenylmethane diisocyanate prepolymer component and a diphenylmethane diisocyanate monomer component. A method for making a sealant including providing a base component containing a hydroxy-terminated toluenediisocyanate/polyoxyalkylene polyol prepolymer, an activator component containing an isocyanate-terminated toluenediisocyanate/polyoxyalkylene polyol, and a modifier component containing at least one of a diphenylmethane diisocyanate prepolymer and a diphenylmethane diisocyanate monomer, and combining the base component, activator component, and modifier component to form a polyurethane reaction product.

### CROSS REFERENCE TO RELATED APPLICATIONS

This application claims the benefit of the filing date of United States Provisional Application for Patent Serial No. 60/460,741 filed Apr. 4, 2003.

### BACKGROUND

Sealants are used to isolate an environment, serving as a barrier to the passage of gases, liquids, and solid particles. Sealants also serve to attenuate mechanical shock, vibration, and sound, maintain a pressure differential, and protect items mechanically, electrically, and thermally.

The largest use of sealants is in commercial and home construction and repair, and in the transportation market. Exterior commercial construction sealants must accommodate large changes in joint gap or width from temperature cycling and wind loads. In addition, the sealants must resist rain, heat, ultraviolet light, oxygen, and ozone. Building materials such as stone, marble, aluminum, steel, glass, and plastics differ widely in thermal coefficients of expansion, so joint design is very important for sections of different materials that are fitted together. The gap width between sections is based on material type and length of section, with a wider gap for larger sections. Sealants are commonly used for expansion joints in parking decks.

Only high performance sealants are suitable for commercial building and construction for exterior sealing. High performance sealants can typically accommodate significant joint movement in compression or tension with good recovery.

Polyurethanes have suitable properties for many useful products, including elastomeric sealants prepared from the reaction of hydroxy-functional components with isocyanate-functional components. Polyurethanes have utility as high performance sealants.

Nonreactive materials are commonly used as plasticizers in sealant formulations to lower modulus. Since these plasticizers are typically nonreactive, however, they may diffuse out of the sealant with time, resulting in a degradation of properties such as an increase in modulus and embrittlement for the sealant, and possible environmental harm due to chemical characteristics of the plasticizers.

Sealants are typically painted for aesthetic purposes to match sections of building material, and also to impart increased weathering protection. Sealants typically are not paintable in the absence of a primer, and thus require at least two paint application steps, the first with a primer or tiecoat, and a second application step using a standard paint or topcoat for aesthetic or protective purposes. Adequate performance, including adhesion of the paint to the sealant, is typically not obtained in the absence of a primer.

What is needed in the art is a high performance sealant with an appropriately low modulus to accommodate significant joint movement in compression or tension without a plasticizer component that might diffuse out to result in degradation of properties and possible environmental harm. What is also needed in the art is a high performance sealant that is paintable in the absence of a primer, thus saving the time and expense of a primer application step.

### SUMMARY

A polyurethane sealant is provided, comprising the reaction product of a hydroxy-terminated toluenediisocyanate/polyoxyalkylene polyol prepolymer component, an isocyanate-terminated toluenediisocyanate/polyoxyalkylene polyol activator component, and at least one of a diphenylmethane diisocyanate prepolymer component and a diphenylmethane diisocyanate monomer component, wherein the polyurethane sealant is paintable in the absence of a primer and has a 100% modulus of less than about 100 pounds per square inch (psi) in the absence of a plasticizer, and wherein diphenylmethane diisocyanate (calculated as monomer) is about 1% to about 3% by weight of the reaction product.

A multicomponent formulation is provided, comprising (a) a hydroxy-terminated toluenediisocyanate/polyoxyalkylene polyol prepolymer component, (b) an isocyanate-terminated toluenediisocyanate/polyoxyalkylene polyol activator component, and (c) at least one of a diphenylmethane diisocyanate prepolymer component and a diphenylmethane diisocyanate monomer component, wherein when components (a), (b), and (c) are combined, a polyurethane reaction product is formed that is paintable in the absence of a primer and has a 100% modulus of less than about 100 psi in the absence of a plasticizer, and wherein diphenylmethane diisocyanate (calculated as monomer) is about 1% to 3% by weight of the reaction product.

A method is provided for making a sealant, which comprises providing a base component, an activator component, and a modifier component, wherein the base component comprises a hydroxy-terminated toluenediisocyanate/polyoxyalkylene polyol prepolymer, the activator component comprises an isocyanate-terminated toluenediisocyanate/polyoxyalkylene polyol activator, and the modifier component comprises at least one of a diphenylmethane diisocyanate prepolymer and a diphenylmethane diisocyanate monomer, and combining the base component, activator component, and modifier component to form a polyurethane reaction product, wherein the reaction product is paintable in the absence of a primer and has a 100% modulus of less than about 100 psi in the absence of a plasticizer, and wherein diphenylmethane diisocyanate (calculated as monomer) is about 1% to 3% by weight of the reaction product.

### DETAILED DESCRIPTION

A polyurethane sealant is provided, comprising the reaction product of a hydroxy-terminated toluenediisocyanate/polyoxyalkylene polyol prepolymer component, an isocyanate-terminated toluenediisocyanate/polyoxyalkylene polyol activator component, and at least one of a diphenylmethane diisocyanate prepolymer component and a diphenylmethane diisocyanate monomer component, wherein the polyurethane sealant is paintable in the absence of a primer and has a 100% modulus of less than about 100 psi in the absence of a plasticizer, and wherein diphenylmethane diisocyanate (calculated as monomer) is about 1% to about 3% by weight of the reaction product. In certain embodiments, the polyurethane sealant is substantially plasticizer-free.

The performance capabilities of the sealant can be expressed in terms of measured physical properties such as tensile strength, elongation percentage, and tensile stress at 100% elongation, often referred to as 100% modulus, measured by a standard test method such as ASTM D 412. Tensile strength is the force, measured in units such as pounds per square inch or psi, needed to stretch a material until it breaks. Elongation percentage or elongation at break is how much the material stretches before it breaks, as a percentage of its original dimensions. The 100% modulus is the force needed to stretch the material to twice its original dimensions.

The polyoxyalkylene polyols of the hydroxy-terminated toluenediisocyanate/polyoxyalkylene polyol prepolymer component and the isocyanate-terminated toluenediisocyanate/polyoxyalkylene polyol activator component may be diols, or higher functionality polyols may be used alone or in admixture with diols. Representative examples of polyoxyalkylene polyols include but are not limited to polyethylene ether glycol, polypropylene ether glycol, poly(tetramethylene ether)glycol, and polyethers prepared by the copolymerization of cyclic ethers such as ethylene oxide, propylene oxide, trimethylene oxide, tetrahydrofuran, and mixtures thereof, with aliphatic polyols such as ethylene glycol, 1,3-butanediol, diethylene glycol, dipropylene glycol, 1,2-propylene glycol, 1,3-propylene glycol, and mixtures thereof, as well as mixtures selected from the foregoing.

A polyoxyalkylene polyol may be produced at industrial scale by addition polymerization of an alkylene oxide to an active hydrogen compound in the presence of an alkali metal catalyst such as potassium hydroxide. Polyoxyalkylene polyols produced in this way are often referred to as conventional polyethers, and contain varying amounts of monofunctional byproducts which are referred to as monols. Technologies are available that allow the production of what are referred to as low-monol polyethers through the use of double metal cyanide complexes as catalysts for polymerization of propylene oxide. The resulting polymers contain extremely low levels of monols. Representative examples of conventional polyoxypropylene polyols include Poly-G® 20-28, a diol with a molecular weight of about 4,000 (available from Arch Chemicals, Inc., Norwalk, Conn.), and Voranol™ 230-112, a triol with a molecular weight of about 1,500, (available from Dow Chemical Company, Midland, Mich.). Examples of low-monol polyoxypropylene polyols include Acclaim™ Polyol 4,200, a diol with a molecular weight of about 4,000, and Acclaim™ Polyol 6,300, a triol with a molecular weight of about 6,000 (both available from Bayer Corporation, Pittsburgh, Pa.).

In one embodiment, the polyoxyalkylene polyols have molecular weights in the range of about 600 to about 12,000. In another embodiment, the polyoxyalkylene polyols have molecular weights in the range of about 800 to about 8,000. In yet another embodiment, the polyoxyalkylene polyols have molecular weights in the range of about 2,000 to about 7,000.

For illustration purposes but not by way of limitation, the polyoxyalkylene polyol of the hydroxy-terminated toluenediisocyanate/polyoxyalkylene polyol prepolymer component may be selected from the group consisting of polyethylene ether glycol, polypropylene ether glycol, poly(tetramethylene ether)glycol, and mixtures thereof. The polyoxyalkylene polyol of the isocyanate-terminated toluenediisocyanate/polyoxyalkylene polyol activator component may be selected from the group consisting of polyethylene ether glycol, polypropylene ether glycol, poly(tetramethylene ether)glycol, and mixtures thereof.

In certain embodiments, the diphenylmethane diisocyanate prepolymer component additionally comprises an allophanate. In other embodiments, the diphenylmethane diisocyanate prepolymer component additionally comprises a polyoxyalkylene polyol of the types set out above. The diphenylmethane diisocyanate prepolymer component can be isocyanate-terminated or it can be hydroxy-terminated.

In certain embodiments, chain extenders may be included in at least one reaction product component. Examples of chain extenders include but are not limited to hydroxyl containing chain extenders such as ethylene glycol, 1,3-propanediol, 2-methyl-1,3-propanediol, 1,4-butanediol, neopentyl glycol, and diethylene glycol, and amine containing chain extenders such as ethylene diamine, 1,3-propanediamine, 1,4-butanediamine, 1,3-pentanediamine, 1,5-pentanediamine, 1,6-hexame diamine, and 2-methylpentamethylenediamine.

In certain embodiments, diphenylmethane diisocyanate (calculated as monomer) may comprise about 1% to about 2% by weight of the reaction product. In other embodiments, diphenylmethane diisocyanate (calculated as monomer) may comprise about 2% to about 3% by weight of the reaction product. In either of these embodiments, toluenediisocyanate (calculated as monomer) may comprise about 1% to about 20% by weight of the reaction product.

In the polyurethane sealants provided, the mole ratio of isocyanate-terminated end groups to hydroxy-terminated end groups is generally about 0.5:1 to about 3:1.

Polyurethane sealants are generally supplied to the trade as multicomponent formulations which generally comprise a base component and an activator component. Accordingly, a multicomponent formulation is provided, comprising (a) a hydroxy-terminated toluenediisocyanate/polyoxyalkylene polyol prepolymer component, (b) an isocyanate-terminated toluenediisocyanate/polyoxyalkylene polyol activator component, and (c) at least one of a diphenylmethane diisocyanate prepolymer component and a diphenylmethane diisocyanate monomer component, wherein when components (a), (b), and (c) are combined, a polyurethane reaction product is formed that is paintable in the absence of a primer and has a 100% modulus of less than about 100 psi in the absence of a plasticizer, and wherein diphenylmethane diisocyanate (calculated as monomer) is about 1% to 3% by weight of the reaction product. In certain embodiments, the diphenylmethane diisocyanate prepolymer component of the multicomponent formulation is isocyanate-terminated. In other embodiments, the diphenylmethane diisocyanate prepolymer component of the multicomponent formulation is hydroxy-terminated. The diphenylmethane diisocyanate component may be provided in mixture with the base component if it is a hydroxy-terminated diphenylmethane diisocyanate prepolymer, or in mixture with the activator component if the diphenylmethane diisocyanate is in monomeric form or is an isocyanate-terminated prepolymer.

In certain embodiments, the hydroxy-terminated toluenediisocyanate/polyoxyalkylene polyol prepolymer component may have a number average molecular weight in the range of about 3000 to about 20000. The molecular weight is either a calculated molecular weight, i.e. the sum of the atomic weights of the atoms making up the material, or the molecular weight is a number average molecular weight determined based on end group analysis or measurement of colligative properties by ebulliometry, cryoscopy, or membrane osmometry. In other embodiments, the hydroxy-terminated toluenediisocyanate/polyoxyalkylene polyol prepolymer component may have a number average molecular weight in the range of about 6,000 to about 15,000.

In certain embodiments, the isocyanate-terminated toluenediisocyanate/polyoxyalkylene polyol activator component may have a number average molecular weight in the range of about 1000 to about 4000. In other embodiments, the isocyanate-terminated toluenediisocyanate/polyoxyalkylene polyol activator component may have a number average molecular weight in the range of about 1500 to about 3500.

In certain embodiments, the diphenylmethane diisocyanate component may have a number average molecular weight in the range of about 250 to about 4000. In other embodiments, the diphenylmethane diisocyanate component may have a number average molecular weight in the range of about 250 to about 2000. The diphenylmethane diisocyanate component may comprise diphenylmethane diisocyanate monomer, a diphenylmethane diisocyanate prepolymer, or combinations thereof.

The hydroxy-terminated toluenediisocyanate/polyoxyalkylene polyol prepolymer component may comprise about 10% to about 92% by weight of the reaction product. In other embodiments, the hydroxy-terminated toluenediisocyanate/polyoxyalkylene polyol prepolymer component may comprise about 20% to about 80% by weight of the reaction product.

The isocyanate-terminated toluenediisocyanate/polyoxyalkylene polyol activator component may comprise about 1% to about 40% by weight of the reaction product. In other embodiments, the isocyanate-terminated toluenediisocyanate/polyoxyalkylene polyol activator component may comprise about 5% to about 20% by weight of the reaction product.

In certain embodiments, a polyurethane sealant is provided, wherein the sealant has a 100% modulus of less than about 100 psi. In other embodiments, the polyurethane sealant has a 100% modulus of about 20 psi to about 95 psi. In yet other embodiments, the polyurethane sealant has a 100% modulus of about 40 psi to about 90 psi.

In certain embodiments, the polyurethane sealant has a tensile strength of about 90 psi or greater. In other embodiments, the polyurethane sealant has a tensile strength of about 100 psi or greater. In yet other embodiments, the polyurethane sealant has a tensile strength of about 110 psi or greater.

In certain embodiments, the polyurethane sealant has an elongation at break of about 200% or greater. In other embodiments, the polyurethane sealant has an elongation of about 240% or greater. In yet other embodiments, the polyurethane sealant has an elongation of about 280% or greater.

The described polyurethane reaction products and sealants may optionally comprise one or more additional components which may include, but are not limited to, UV absorbers, antioxidants, stabilizers, mildewcides, biocides, fungicides, fire and flame retardants, fillers, pigments, catalysts, adhesion promoters, flow and leveling additives, wetting agents, antifoaming agents, rheology modifiers, and mixtures thereof. By way of example, but not limitation, the base component may optionally comprise up to about 5 percent by weight of UV absorbers, up to about 5 percent by weight of antioxidants, up to about 5 percent by weight of stabilizers, up to about 2 percent by weight of mildewcides, up to about 2 percent by weight of biocides, up to about 2 percent by weight of fungicides, up to about 20 percent by weight of fire or flame retardants, from about 20 to about 80 percent by weight of fillers, up to about 10 percent by weight of pigments, up to about 5 percent by weight of catalysts, up to about 5 percent by weight of adhesion promoters, up to about 10 percent by weight of flow and leveling additives, up to about 5 percent by weight of wetting agents, up to about 2 percent by weight of antifoaming agents, and/or up to about 20 percent by weight of rheology modifiers.

UV absorbers, stabilizers, antioxidants, mildewcides, biocides, and fungicides are materials known to those skilled in the art, and protect the sealants from harmful effects of weathering and biological agents.

UV stabilizers may comprise 2-(2′-hydroxyphenyl)benzotriazoles, 2-hydroxybenzophenones, esters of substituted and unsubstituted benzoic acids, acrylates, nickel compounds, sterically hindered amines, oxanilides, 2-(2-hydroxyphenyl)-1,3,5-triazines, and mixtures thereof.

Representative examples of 2-(2′-hydroxyphenyl)benzotriazole, UV stabilizers include but are not limited to 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(alpha, alpha-dimethylbenzyl)-2′-hydroxyphenyl)benzotriazole, mixtures of 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)-benzotriazole, 2-(3′-tert-butyl-5′-[2-(2-ethylhexyloxy)carbonylethyl]-2′-hydroxyphenyl)-benzotriazole, 2-(3′-dodecyl-2′-hydroxy-5′-methylphenyl)benzotriazole, and 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol], the transesterification product of 2-[3′-tert-butyl-5′-(2-methoxycarbonylethyl)-2′-hydroxyphenyl]-2H-benzotriazole with polyethylene glycol 300, and mixtures thereof.

Representative examples of 2-hydroxybenzophenone UV stabilizers include but are not limited to the 4-hydroxy, 4-methoxy, 4-octyloxy, 4-decyloxy, 4-dodecyloxy, 4-benzyloxy, 4,2′,4′-trihydroxy, or 2′-hydroxy-4,4′-dimethoxy derivatives, and mixtures thereof.

Representative examples of esters of substituted and unsubstituted benzoic acid UV stabilizers include but are not limited to 4-tert-butyl-phenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate, and mixtures thereof.

Representative examples of acrylate UV stabilizers include but are not limited to ethyl alpha-cyano-beta, beta-diphenylacrylate, isooctyl alpha-cyano-beta, beta-diphenylacrylate, methyl alpha-carbomethoxycinnamate, methyl alpha-cyano-beta-methyl-p-methoxy-cinnamate, butyl alpha-cyano-beta-methyl-p-methoxy-cinnamate, methyl alpha-carbomethoxy-p-methoxycinnamate, N-(beta-carbomethoxy-beta-cyanovinyl)-2-methylindoline, and mixtures thereof.

Representative examples of nickel compound UV stabilizers include but are not limited to nickel complexes of 2,2′-thio-bis-[4-(1,1,3,3-tetra-methylbutyl)phenol] such as the 1:1 or 1:2 complex with or without additional ligands such as n-butylamine, triethanolamine or N-cyclohexyldiethanolamine, nickel dibutyldithiocarbamate, nickel salts of the monoalkyl esters such as the methyl or ethyl ester of 4-hydroxy-3,5-di-tert-butylbenzylphosphonic acid, nickel complexes of ketoximes such as 2-hydroxy-4-methylphenyl undecylketoxime, nickel complexes of 1-phenyl-4-lauroyl-5-hydroxypyrazole with or without additional ligands, and mixtures thereof.

Representative examples of sterically hindered amine UV stabilizers include but are not limited to bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, the condensate of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis-(2,2,6,6-tetramethyl-4-piperidyl)-1,2,3,4-butane-tetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decan-2,4-dion, bis(1-octyloxy-2,2,6,6-tetramethylpiperidyl)sebacate, bis(1-octyloxy-2,2,6,6-tetramethylpiperidyl)succinate, the condensate of N,N′-bis-(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis-(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidin-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensation product of N,N′-bis(2,2,6,6-tetramethyl-4-piperidyl)hexamethylenediamine and 4-cyclohexylamino-2,6-dichloro-1,3,5-triazine, a condensation product of 1,2-bis(3-aminopropylamino)ethane and 2,4,6-trichloro-1,3,5-triazine, 4-butylamino-2,2,6,6-tetramethylpiperidine, N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro [4,5]decane and epichlorohydrin, and mixtures thereof.

Representative examples of oxanilide UV stabilizers include but are not limited to 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxanilide, 2-ethoxy-5-tert-butyl-2′-ethoxanilide and its mixture with 2-ethoxy-2′-ethyl-5,4′-di-tert-butoxanilide, mixtures of ortho- and para-methoxy-disubstituted oxanilides, mixtures of o- and p-ethoxy-disubstituted oxanilides, and mixtures thereof.

Representative examples of 2-(2-hydroxyphenyl)-1,3,5-triazine UV stabilizers include but are not limited to 2,4,6-tris(2-hydroxy-4-octyloxy-phenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxy-propoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxy-phenyl]-4,6-bis(2,4-dimethylphenyl)-1,3,5-triazine, 2-[2-hydroxy-4-(2-hydroxy-3-dodecyloxy-propoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, and mixtures thereof.

Antioxidants may comprise alkylated monophenols, alkylthiomethylphenols, hydroquinones and alkylated hydroquinones, tocopherols, hydroxylated thiodiphenyl ethers, alkylidenebisphenols, O-, N- and S-benzyl compounds, hydroxybenzylated malonates, aromatic hydroxybenzyl compounds, triazine compounds, benzylphosphonates, acylaminophenols, esters of beta-(3,5-di-tert-butyl-4-hydroxyphenyl)propionic acid with mono- or polyhydric alcohols, esters of beta-(5-tert-butyl-4-hydroxy-3-methylphenyl)propionic acid with mono- or polyhydric alcohols, esters of beta-(3,5-dicyclohexyl-4-hydroxyphenyl)propionic acid with mono- or polyhydric alcohols, esters of 3,5-di-tert-butyl-4-hydroxyphenyl acetic acid with mono- or polyhydric alcohols, amides of beta-(3,5-di-tert-butyl-4-hydroxyphenyl)propionic acid, ascorbic acid and derivatives, aminic antioxidants, and mixtures thereof.

Representative examples of alkylated monophenol antioxidants include but are not limited to 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(alpha-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols with linear or branched side chains such as 2,6-di-nonyl-4-methylphenol, 2,4-dimethyl-6-(1′-methylundec-1′-yl)-phenol, 2,4-dimethyl-6-(1′-methylheptadec-1′-yl)phenol, 2,4-dimethyl-6-(1′-methyltridec-1′-yl)phenol, and mixtures thereof.

Representative examples of alkylthiomethylphenol antioxidants include but are not limited to 2,4-dioctylthiomethyl-6-tert-butylphenol, 2,4-di-octylthiomethyl-6-methylphenol, 2,4-dioctylthiomethyl-6-ethylphenol, 2,6-di-dodecylthiomethyl-4-nonylphenol, and mixtures thereof.

Representative examples of hydroquinone and alkylated hydroquinone antioxidants include but are not limited to 2,6-di-tert-butyl-4-methoxy-phenol, 2,5-di-tert-butylhydroquinone, 2,5-di-tert-amylhydroquinone, 2,6-diphenyl-4-octa-decyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis-(3,5-di-tert-butyl-4-hydroxyphenyl) adipate, and mixtures thereof.

Representative examples of tocopherol antioxidants include but are not limited to alpha-tocopherol, beta-tocopherol, gamma-tocopherol, delta-tocopherol, and mixtures thereof, including Vitamin E.

Representative examples of hydroxylated thiodiphenyl ether antioxidants include but are not limited to 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis-(3,6-di-sec-amylphenol), 4,4′-bis-(2,6-dimethyl-4-hydroxyphenyl)disulfide, and mixtures thereof.

Representative examples of alkylidenebisphenol antioxidants include but are not limited to 2,2′-methylenebis(6-tert-butyl-4-methylphenol), 2,2′-methylenebis(6-tert-butyl-4-ethylphenol), 2,2′-methylenebis[4-methyl-6-(alpha-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(alpha-methylbenzyl)-4-nonylphenol], 2,2′-methylenebis[6-(alpha, alpha-dimethylbenzyl)-4-nonyl-phenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methyl-phenyl)butane, 1,1-bis(5-tert-butyl-4-hydroxy-2-methyl-phenyl)-3-n-dodecylmercapto-butane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxy-phenyl)butane, 2,2-bis-(3,5-di-tert-butyl-4-hydroxyphenyl)propane, 2,2-bis-(5-tert-butyl-4-hydroxy-2-methylphenyl)-4-n-dodecylmercaptobutane, 1,1,5,5-tetra-(5-tert-butyl-4-hydroxy-2-methylphenyl)pentane, and mixtures thereof.

Representative examples of O-, N- and S-benzyl compound antioxidants include but are not limited to 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate, and mixtures thereof.

Representative examples of hydroxybenzylated malonate antioxidants include but are not limited to dioctadecyl-2,2-bis-(3,5-di-tert-butyl-2-hydroxybenzyl)-malonate, di-octadecyl-2-(3-tert-butyl-4-hydroxy-5-methylbenzyl)-malonate, di-dodecylmercaptoethyl-2,2-bis-(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate, and mixtures thereof.

Representative examples of aromatic hydroxybenzyl compound antioxidants include but are not limited to 1,3,5-tris-(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol, and mixtures thereof.

Representative examples of triazine compound antioxidants include but are not limited to 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris-(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate, and mixtures thereof.

Representative examples of benzylphosphonate antioxidants include but are not limited to dimethyl-2,5-di-tert-butyl-4-hydroxybenzylphosphonate, diethyl-3,5-di-tert-butyl-4-hydroxybenzylphosphonate, dioctadecyl-3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid, and mixtures thereof.

Representative examples of acylaminophenol antioxidants include but are not limited to 4-hydroxylauranilide, 4-hydroxystearanilide, octyl N-(3,5-di-tert-butyl-4-hydroxyphenyl)carbamate, and mixtures thereof.

Representative examples of esters of beta-(3,5-di-tert-butyl-4-hydroxyphenyl)propionic acid with mono- or polyhydric alcohols suitable for use as antioxidants include but are not limited to those with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane, and mixtures thereof.

Representative examples of esters of beta-(5-tert-butyl-4-hydroxy-3-methylphenyl)propionic acid with mono- or polyhydric alcohols suitable for use as antioxidants include but are not limited to those with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo-[2.2.2]octane, and mixtures thereof.

Representative examples of esters of beta-(3,5-dicyclohexyl-4-hydroxyphenyl)propionic acid with mono- or polyhydric alcohols suitable for use as antioxidants include but are not limited to those with methanol, ethanol, octanol, octadecanol, 1,6-hexanediol, 1,9-nonanediol, ethylene glycol, 1,2-propanediol, neopentyl glycol, thiodiethylene glycol, di-ethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane, and mixtures thereof.

Representative examples of esters of 3,5-di-tert-butyl-4-hydroxyphenyl acetic acid with mono- or polyhydric alcohols suitable for use as antioxidants include but are not limited to those with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)-oxamide, 3-thiaundecanol, 3-thiapentadecanol, trimethylhexanediol, trimethylolpropane, 4-hydroxymethyl-1-phospha-2,6,7-trioxabicyclo[2.2.2]octane, and mixtures thereof.

Representative examples of amides of beta-(3,5-di-tert-butyl-4-hydroxyphenyl)propionic acid suitable for use as antioxidants include but are not limited to N,N′-bis(3,5-di-tert-butyl-4-hydroxyphenylpropionyl)hexamethylenediamine, N,N′-bis(3,5-di-tert-butyl-4-hydroxyphenylpropionyl)trimethylenediamine, N,N′-bis(3,5-di-tert-butyl-4-hydroxyphenylpropionyl)hydrazine, and mixtures thereof.

Representative examples of ascorbic acid and derivative antioxidants include but are not limited to salts or esters of ascorbic acid such as ascorbyl palmitate, dipalmitate L-ascorbate, sodium L-ascorbate-2-sulfate, inorganic ascorbic salts such as sodium, potassium, and calcium, and mixtures thereof, and combinations thereof.

Representative examples of aminic antioxidants include but are not limited to N,N′-di-isopropyl-p-phenylenediamine, N,N′-di-sec-butyl-p-phenylenediamine, N,N′-bis(1,4-dimethylpentyl)-p-phenylenediamine, N,N′-bis-(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, mixtures of mono- and dialkylated tert-butyl/tert-octyldiphenylamines, mixtures of mono- and dialkylated nonyldiphenylamines, mixtures of mono- and dialkylated dodecyldiphenylamines, mixtures of mono- and dialkylated isopropyl/isohexyldiphenylamines, mixtures of mono- and dialkylated tert-butyldiphenylamines, 2,3-dihydro-3,3-dimethyl-4H-1,4-benzothiazine, phenothiazine, mixtures of mono- and dialkylated tert-butyl/tert-octylphenothiazines, mixtures of mono- and dialkylated tert-octyl-phenothiazines, N-allylphenothiazine, N,N,N′,N′-tetraphenyl-1,4-diaminobut-2-ene, N,N-bis(2,2,6,6-tetramethyl-piperid-4-yl-hexamethylenediamine, bis(2,2,6,6-tetramethylpiperid-4-yl)sebacate, 2,2,6,6-tetramethylpiperidin-4-one, 2,2,6,6-tetramethylpiperidin-4-ol, and mixtures thereof.

Fungicides, mildewcides, and biocides may comprise 4,4-dimethyloxazolidine, 3,4,4-trimethyloxazolidine, modified barium metaborate, potassium N-hydroxy-methyl-N-methyldithiocarbamate, 2-(thiocyanomethylthio) benzothiazole, potassium dimethyl dithiocarbamate, adamantane, N-(trichloromethylthio)phthalimide, 2,4,5,6-tetrachloroisophthalonitrile, orthophenyl phenol, 2,4,5-trichlorophenol, dehydroacetic acid, copper naphthenate, copper octoate, organic arsenic, tributyl tin oxide, zinc naphthenate, copper 8-quinolinate, and mixtures thereof.

The fire retardants may comprise any material that provides self extinguishing properties. Suitable examples of the fire retardant include, but are not limited to, phosphates such as triphenyl phosphate, polyammonium phosphate, monoammonium phosphate, or tri(2-chloroethyl)phosphate, melamine, exfoliated graphite, acid treated natural graphite flakes, and mixtures thereof. The fire retardant can be a liquid or a solid. A solid fire retardant may be ground to a micron size, typically referred to as micronized. Additionally, the fire retardant may include but is not limited to self extinguishing agents and flame retardants. In one embodiment, the fire retardant is polyammonium phosphate. In another embodiment, an aluminum oxide smoke retardant is used in combination with the polyammonium phosphate.

The polyurethane sealant may also comprise a filler, In one embodiment a solid inert to other materials in the sealant. Suitable examples of the filler include, but are not limited to, carbon black, titanium dioxide, glass, such as crushed glass or glass spheres, metal such as iron particles, quartz, silica such as hydrophilic silica, hydrophobic amorphous fumed silica, and amorphous precipitated silica, barytes, limestone, sulfates, alumina, various clays, diatomaceous earth, wollastonite, mica, perlite, flint powder, kryolite, alumina trihydrate, talc, polymer granules and powders such as granulated or micronized polyethylene and granulated or micronized polypropylene, melamine, fibers such as polypropylene or nylon, zinc oxide, and mixtures thereof. Carbon black and titanium dioxide may be used as both a filler and a pigment.

The polyurethane sealant may also comprise a coloring agent, such as a pigment or a dye, to provide a desired color to the sealant. Examples of coloring agents are carbon black and titanium dioxide which may be in the rutile form, but other coloring agents are also useful. Carbon black and titanium dioxide may act as both pigments and fillers in the sealant. Additional examples of pigments include, but are not limited to, barium sulfate, zinc oxide, zinc sulfide, basic lead carbonate, antimony trioxide, lithopones (zinc sulfide and barium sulfate), inorganic color pigments such as iron oxides, carbon black, graphite, luminescent pigments, zinc yellow, zinc green, ultramarine, manganese black, antimony black, manganese violet, Paris blue, and Schweinfurter green, organic color pigments such as sepia, gamboge, Cassel brown, toluidine red, para red, Hansa yellow, indigo, azo dyes, anthraquinonoid and indigoid dyes, as well as dioxazine, quinacridone, phthalocyanine, isoindolinone, and metal complex pigments, and mixtures thereof.

The polyurethane sealant may additionally comprise surface additives such as flow and leveling additives, wetting agents, and antifoaming agents to facilitate application of the material. Examples of flow and leveling additives, wetting agents, and antifoaming agents include silicones, modified silicones, polyacrylates, and hydrocarbons such as petroleum components and mixtures. Examples of suitable flow additives include, but are not limited to, polyester modified acrylic functional poly-di-methyl siloxanes such as BYK®-371, and polyacrylate copolymers such as BYK®-358, (both available from BYK-Chemie USA, Wallingford, Conn.), and fluorosurfactants such as 3M™ Fluorad™ FC-4430 Fluorosurfactant (available from 3M Company, St. Paul, Minn.).

The polyurethane sealant may additionally comprise an adhesion promoter. Examples of adhesion promoters include, but are not limited to

2-aminoethyl-dimethylmethoxysilane; 6-aminohexyl-tributoxysilane;

3-aminopropyl-trimethoxysilane; 3-aminopropyl-triethoxysilane;

3-aminopropyl-methyldiethoxysilane; 5-aminopentyl-trimethoxysilane;

5-aminopentyl-triethoxysilane and 3-aminopropyl-triisopropoxysilane,

γ-glycidoxypropyltrimethoxysilane, γ-glycidoxypropyltriethoxysilane,

γ-mercaptopropyltrimethoxysilane, γ-mercaptopropyltriethoxysilane, and,

γ-ureidopropyltrimethoxysilane, and γ-ureidopropyltriethoxysilane.

The polyurethane sealant may also comprise a rheology modifier to increase the viscosity of the material immediately after application to a substrate. This can prevent the sealant from dripping or running when initially applied to a substrate. Suitable examples of the rheology modifier include, but are not limited to, fumed silica, hydroxyethyl cellulose, hydroxypropyl cellulose, polyamide waxes, modified castor oil, and clay intercalated with organic cations.

The additional sealant components may be incorporated separately or may be combined with the hydroxy-terminated toluenediisocyanate/polyoxyalkylene polyol prepolymer component, the isocyanate-terminated toluenediisocyanate/polyoxyalkylene polyol activator component, the diphenylmethane diisocyanate prepolymer component, and/or the diphenylmethane diisocyanate monomer component.

A method is provided for making a sealant comprising (a) providing a base component, an activator component, and a modifier component, wherein the base component comprises a hydroxy-terminated toluenediisocyanate/polyoxyalkylene polyol prepolymer, the activator component comprises an isocyanate-terminated toluenediisocyanate/polyoxyalkylene polyol activator, and the modifier component comprises at least one of a diphenylmethane diisocyanate prepolymer and a diphenylmethane diisocyanate monomer, and (b) combining the base component, activator component, and modifier component to form a polyurethane reaction product, wherein the reaction product is paintable in the absence of a primer and has a 100% modulus of less than about 100 psi in the absence of a plasticizer, and wherein diphenylmethane diisocyanate (calculated as monomer) is about 1% to 3% by weight of the reaction product. In certain embodiments of the described method, the reaction product has a 100% modulus of about 40 psi to about 90 psi.

In one embodiment, the modifier component is combined with the activator component prior to combination with the base component. In another embodiment, the modifier component is combined with the base component prior to combination with the activator component. The reaction product is applied to a substrate, such as the surface of concrete, stone, metal, glass, plastic, wood, or composite materials, by techniques known in the art, prior to the cure of the sealant. Application techniques may include, but are not limited to, gunning with a caulk gun or professional bulk gun, spraying, brushing, rolling, and combinations thereof.

Improved performance is typically obtained for clean and dry substrate surfaces. Surface preparation before sealant application can include water-blasting, sandblasting, cleaning, and drying of concrete surfaces, cleaning of metal surfaces with organic solvents, scuff-sanding and organic solvent wiping of composite surfaces, flame-etching of plastic surfaces, and the like.

When applied to a substrate, in certain embodiments, a polyurethane sealant is provided that is at least about 0.25 inch thick. In other embodiments, the polyurethane sealant is about 0.25 inch to about 0.5 inch thick. In yet other embodiments, the polyurethane sealant is about 0.125 inch to about 0.75 inch thick.

When utilized as an expansion joint for a parking deck, in certain embodiments, a polyurethane sealant is provided that is at least about 0.25 inch thick. In other embodiments, the polyurethane sealant is about 0.25 inch to about 1 inch thick. In yet other embodiments, the polyurethane sealant is about 0.25 inch to about 1.25 inch thick.

Paint adhesion is typically evaluated using a standard test method such as ASTM D3359. Using this cross-hatch adhesion test method, a rating of 5B is given to the sample if the edges of the cuts are completely smooth and none of the squares of the lattice is detached, therefore 100% adhesion and 0% adhesion failure. A rating of 4B applies if small flakes of the coating are detached at intersections of cuts, and less than 5% of the area is affected, therefore 5% adhesion failure. A rating of 3B applies if small flakes of the coating are detached along edges and at intersections of cuts, and the adhesion failure area is 5 to 15% of the lattice. A rating of 2B applies if the coating has flaked along the edges and on parts of the squares, and the adhesion failure area is 15 to 35% of the lattice. A rating of 1B applies if the coating has flaked along the edges of cuts in large ribbons and whole squares have detached, and the adhesion failure area is 35 to 65% of the lattice. A rating of 0B applies if flaking and detachment is worse than Grade 1B, corresponding to adhesion failure area of greater than 65% of the lattice.

In one embodiment, the polyurethane sealant reaction product is paintable in the absence of a primer such that paint adheres to the surface of the sealant with a rating of at least 4B when tested according to the paint adhesion test ASTM D3359. In another embodiment, paint adheres to the surface of the sealant with a rating of 5B when tested according to the paint adhesion test ASTM D3359. The types of paint that adhere to the surface of the sealant include latex paint, solvent-borne paint, and solvent-free paint.

The following examples are given to illustrate the preparation of a polyurethane sealant as discussed above. In the following examples, the quantities of activator and added diphenylmethane diisocyanate components were adjusted to maintain a constant number of isocyanate groups in the reaction mixture.

### EXAMPLE 1

134.6 grams of SONOLASTIC™ NP2 base (a hydroxy-terminated toluenediisocyanate/polyoxyalkylene polyol prepolymer in a mixture with fillers, catalysts and other additives) and 17.0 grams of SONOLASTIC™ NP2 Activator (an isocyanate-terminated toluenediisocyanate/polyoxyalkylene polyol activator containing mineral spirits and catalysts), (both available from Degussa Building Systems Inc., Shakopee, Minn.), 11.1 grams of black pigment slurry (a slurry of carbon black in a polyoxypropylene ether polyol having a functionality of 3 and an equivalent weight of about 2000), and 2.3 grams Mondur ML (a product of Bayer consisting of an isomer mixture of monomeric diphenylmethane diisocyanate (MDI) with a high proportion (about 52%) of the 2′,4′ isomer) were mixed on a Hauschild mixer. The resulting reaction product was drawn down on a plastic sheet and allowed to cure for five days under ambient conditions. Measurement of physical properties gave a 100% modulus of 56 psi, a peak tensile strength of 112 psi, and an elongation at break of 298%. A portion of the sealant was painted with SONNEBORN COLORFLEX™ paint, an acrylic latex elastomeric paint available from ChemRex Inc. The painted sample was allowed to dry for 1 week under ambient conditions and adhesion was tested according to ASTM D3359, with a result of 5B, corresponding to 100% adhesion.

### EXAMPLE 2

134.6 grams of SONOLASTIC™ NP2 base, 17.0 grams of SONOLASTIC™ NP2 Activator, 11.1 grams of black pigment slurry, and 3.3 grams Mondur MA 2300 (an allophanate modified 4,4′-diphenylmethane diisocyanate (MDI)/4,4′-diphenylmethane diisocyanate (MDI) blend produced by Bayer Corporation) were mixed on a Hauschild mixer. The resulting reaction product was drawn down on a plastic sheet and allowed to cure for five days under ambient conditions. Measurement of physical properties gave a 100% modulus of 58 psi, a peak tensile strength of 121 psi, and an elongation at break of 299%. A portion of the sealant was painted with SONNEBORN COLORFLEX™ paint, an acrylic latex elastomeric paint. The painted sample was allowed to dry for 1 week under ambient conditions and adhesion was tested according to ASTM D3359, with a result of 1B-2B, corresponding to 35-85% adhesion.

### COMPARATIVE EXAMPLE 1

134.6 grams of SONOLASTIC™ NP2 base, 36.3 grams of SONOLASTIC™ NP2 Activator, and 11.1 grams of black pigment slurry were mixed on a Hauschild mixer. The resulting reaction product was drawn down on a plastic sheet and allowed to cure for five days under ambient conditions. Measurement of physical properties gave a 100% modulus of 101 psi, a peak tensile strength of 161 psi, and an elongation at break of 281%. A portion of the sealant was painted with SONNEBORN COLORFLEX™ paint, an acrylic latex elastomeric paint. The painted sample was allowed to dry for 1 week under ambient conditions and adhesion was tested according to ASTM D3359, with a result of 0B, corresponding to less than 35% adhesion and over 65% adhesion loss.

It will be understood that the embodiment(s) described herein is/are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

What is claimed is:

1. A polyurethane sealant comprising the reaction product of:
a) a hydroxy-terminated toluenediisocyanate/polyoxyalkylene polyol prepolymer component;
b) an isocyanate-terminated toluenediisocyanate/polyoxyalkylene polyol activator component; and
c) at least one of:
i) a diphenylmethane diisocyanate prepolymer component; or
ii) a diphenylmethane diisocyanate monomer component;
wherein said polyurethane sealant is paintable in the absence of a primer and has a 100% modulus of less than about 100 psi in the absence of a plasticizer, and wherein diphenylmethane diisocyanate (calculated as monomer) is about 1% to about 3% by weight of said reaction product.

2. The polyurethane sealant of claim 1, wherein the at least one of a diphenylmethane diisocyanate prepolymer component and a diphenylmethane diisocyanate monomer component is provided as a mixture with at least one of a hydroxy-terminated toluenediisocyanate/polyoxyalkylene polyol prepolymer component or an isocyanate-terminated toluenediisocyanate/polyoxyalkylene polyol activator component.

3. The polyurethane sealant of claim 1, wherein the polyoxyalkylene polyol of the hydroxy-terminated toluenediisocyanate/polyoxyalkylene polyol prepolymer component is selected from the group consisting of polyethylene ether glycol, polypropylene ether glycol, poly(tetramethylene ether)glycol, polyethers prepared by the copolymerization of cyclic ethers selected from the group consisting of ethylene oxide, propylene oxide, trimethylene oxide, tetrahydrofuran, and mixtures thereof, with aliphatic polyols selected from the group consisting of ethylene glycol, 1,3-butanediol, diethylene glycol, dipropylene glycol, 1,2-propylene glycol, 1,3-propylene glycol, and mixtures thereof, and combinations thereof.

4. The polyurethane sealant of claim 1, wherein the polyoxyalkylene polyol of the isocyanate-terminated toluenediisocyanate/polyoxyalkylene polyol activator component is selected from the group consisting of polyethylene ether glycol, polypropylene ether glycol, poly(tetramethylene ether)glycol, polyethers prepared by the copolymerization of cyclic ethers selected from the group consisting of ethylene oxide, propylene oxide, trimethylene oxide, tetrahydrofuran, and mixtures thereof, with aliphatic polyols selected from the group consisting of ethylene glycol, 1,3-butanediol, diethylene glycol, dipropylene glycol, 1,2-propylene glycol, 1,3-propylene glycol, and mixtures thereof, and combinations thereof.

5. The polyurethane sealant of claim 1, wherein the diphenylmethane diisocyanate prepolymer component additionally comprises an allophanate.

6. The polyurethane sealant of claim 1, wherein the diphenylmethane diisocyanate prepolymer component additionally comprises a polyoxyalkylene polyol.

7. The polyurethane sealant of claim 1, wherein the diphenylmethane diisocyanate prepolymer component is isocyanate-terminated.

8. The polyurethane sealant of claim 1, wherein the diphenylmethane diisocyanate prepolymer component is hydroxy-terminated.

9. The polyurethane sealant of claim 1, wherein the diphenylmethane diisocyanate (calculated as monomer) is about 1% to about 2% by weight of the reaction product.

10. The polyurethane sealant of claim 1, wherein the diphenylmethane diisocyanate (calculated as monomer) is about 2% to about 3% by weight of the reaction product.

11. The polyurethane sealant of claim 1, wherein the toluenediisocyanate (calculated as monomer) is about 1% to about 20% by weight of the reaction product.

12. The polyurethane sealant of claim 1, wherein the hydroxy-terminated toluenediisocyanate/polyoxyalkylene polyol prepolymer component has a number average molecular weight in the range of about 3,000 to about 20,000.

13. The polyurethane sealant of claim 1, wherein the hydroxy-terminated toluenediisocyanate/polyoxyalkylene polyol prepolymer component has a number average molecular weight in the range of about 6,000 to about 15,000.

14. The polyurethane sealant of claim 1, wherein the isocyanate-terminated toluenediisocyanate/polyoxyalkylene polyol activator component has a number average molecular weight in the range of about 1,000 to about 4,000.

15. The polyurethane sealant of claim 1, wherein the isocyanate-terminated toluenediisocyanate/polyoxyalkylene polyol activator component has a number average molecular weight in the range of about 1,500 to about 3,500.

16. The polyurethane sealant of claim 1, wherein the diphenylmethane diisocyanate component has a number average molecular weight in the range of about 250 to about 4,000.

17. The polyurethane sealant of claim 1, wherein the diphenylmethane diisocyanate component has a number average molecular weight in the range of about 250 to about 2,000.

18. The polyurethane sealant of claim 1, wherein the hydroxy-terminated toluenediisocyanate/polyoxyalkylene polyol prepolymer component comprises about 10% to about 92% by weight of the reaction product.

19. The polyurethane sealant of claim 1, wherein the hydroxy-terminated toluenediisocyanate/polyoxyalkylene polyol prepolymer component comprises about 20% to about 80% by weight of the reaction product.

20. The polyurethane sealant of claim 1, wherein the isocyanate-terminated toluenediisocyanate/polyoxyalkylene polyol activator component comprises about 1% to about 40% by weight of the reaction product.

21. The polyurethane sealant of claim 1, wherein the isocyanate-terminated toluenediisocyanate/polyoxyalkylene polyol activator component comprises about 5% to about 20% by weight of the reaction product.

22. The polyurethane sealant of claim 1, wherein the sealant has a 100% modulus of about 40 psi to about 90 psi.

23. The polyurethane sealant of claim 1, wherein the sealant has a tensile strength of about 100 psi or greater.

24. The polyurethane sealant of claim 1, wherein the sealant has an elongation to break of about 200% or greater.

25. The polyurethane sealant of claim 1, wherein the mole ratio of isocyanate-terminated end groups to hydroxy-terminated end groups is about 0.5:1 to about 3:1.

26. The polyurethane sealant of claim 1, wherein the reaction product additionally comprises at least one component selected from the group consisting of UV absorbers, antioxidants, stabilizers, mildewcides, biocides, fungicides, fire or flame retardants, fillers, pigments, adhesion promoters, flow and leveling additives, wetting agents, antifoaming agents, rheology modifiers, and mixtures thereof.

27. The polyurethane sealant of claim 1, wherein the reaction product additionally comprises at least one UV stabilizer selected from the group consisting of 2-(2′-hydroxyphenyl)benzotriazoles, 2-hydroxybenzophenones, esters of substituted and unsubstituted benzoic acids, acrylates, nickel compounds, sterically hindered amines, oxanilides, 2-(2-hydroxyphenyl)-1,3,5-triazines, and mixtures thereof.

28. The polyurethane sealant of claim 1, wherein the reaction product additionally comprises at least one antioxidant selected from the group consisting of alkylated monophenols, alkylthiomethylphenols, hydroquinones and alkylated hydroquinones, tocopherols, hydroxylated thiodiphenyl ethers, alkylidenebisphenols, O-, N- and S-benzyl compounds, hydroxybenzylated malonates, aromatic hydroxybenzyl compounds, triazine compounds, benzylphosphonates, acylaminophenols, esters of beta-(3,5-di-tert-butyl-4-hydroxyphenyl)propionic acid with mono- or polyhydric alcohols, esters of beta-(5-tert-butyl-4-hydroxy-3-methylphenyl)propionic acid with mono- or polyhydric alcohols, esters of beta-(3,5-dicyclohexyl-4-hydroxyphenyl)propionic acid with mono- or polyhydric alcohols, esters of 3,5-di-tert-butyl-4-hydroxyphenyl acetic acid with mono- or polyhydric alcohols, amides of beta-(3,5-di-tert-butyl-4-hydroxyphenyl)propionic acid, ascorbic acid and derivatives, aminic antioxidants, and mixtures thereof.

29. The polyurethane sealant of claim 1, wherein the reaction product additionally comprises at least one fire or flame retardant selected from the group consisting of triphenyl phosphate, polyammonium phosphate, monoammonium phosphate, tri(2-chloroethyl) phosphate, melamine, exfoliated graphite, acid treated natural graphite flakes, and mixtures thereof.

30. The polyurethane sealant of claim 1, wherein the reaction product additionally comprises at least one filler selected from the group consisting of carbon black, titanium dioxide, zinc oxide, glass spheres, iron particles, quartz, hydrophilic silica, hydrophobic amorphous fumed silica, amorphous precipitated silica, barytes, limestone, sulfates, alumina, clays, diatomaceous earth, wollastonite, mica, perlite, flint powder, kryolite, talc, polymer granules, polymer powders, micronized polymers, melamine, zinc oxide, and mixtures thereof.

31. The polyurethane sealant of claim 1, wherein the reaction product additionally comprises at least one pigment selected from the group consisting of carbon black, titanium dioxide, barium sulfate, zinc oxide, zinc sulfide, basic lead carbonate, antimony trioxide, lithopones, iron oxides, graphite, luminescent pigments, zinc yellow, zinc green, ultramarine, manganese black, antimony black, manganese violet, Paris blue, Schweinfurter green, sepia, gamboge, Cassel brown, toluidine red, para red, Hansa yellow, indigo, azo dyes, anthraquinonoid and indigoid dyes, dioxazine, quinacridone, phthalocyanine, isoindolinone, and metal complex pigments, and mixtures thereof.

32. The polyurethane sealant of claim 1, wherein the reaction product additionally comprises at least one flow and leveling additive, wetting agent, or antifoaming agent selected from the group consisting of silicones, modified silicones, hydrocarbons, polyacrylates, fluorosurfactants, and mixtures thereof.

33. The polyurethane sealant of claim 1, wherein the reaction product additionally comprises at least one rheology modifier selected from the group consisting of fumed silica, hydroxyethyl cellulose, hydroxypropyl cellulose, polyamide waxes, modified castor oil, clay intercalated with organic cations and mixtures thereof.

34. The polyurethane sealant of claim 1, wherein the reaction product additionally comprises at least one adhesion promoter selected from the group consisting of
2-aminoethyl-dimethylmethoxysilane; 6-aminohexyl-tributoxysilane;
3-aminopropyl-trimethoxysilane; 3-aminopropyl-triethoxysilane;
3-aminopropyl-methyldiethoxysilane; 5-aminopentyl-trimethoxysilane;
5-aminopentyl-triethoxysilane and 3-aminopropyl-triisopropoxysilane,
γ-glycidoxypropyltrimethoxysilane, γ-glycidoxypropyltriethoxysilane,
γ-mercaptopropyltrimethoxysilane, γ-mercaptopropyltriethoxysilane, and,
γ-ureidopropyltrimethoxysilane, and γ-ureidopropyltriethoxysilane.

35. The polyurethane sealant of claim 1, wherein at least one reaction product component additionally comprises at least one chain extender selected from the group consisting of hydroxyl containing chain extenders and amine containing chain extenders.

36. The polyurethane sealant of claim 35, wherein said chain extender is selected from the group consisting of ethylene glycol, 1,3-propanediol, 2-methyl-1,3-propanediol, 1,4-butanediol, neopentyl glycol, diethylene glycol, ethylene diamine, 1,3-propanediamine, 1,4-butanediamine, 1,3-pentanediamine, 1,5-pentanediamine, 1,6-hexame diamine, 2-methylpentamethylenediamine, and mixtures thereof.

37. A multicomponent formulation comprising:
a) a hydroxy-terminated toluenediisocyanate/polyoxyalkylene polyol prepolymer component;
b) an isocyanate-terminated toluenediisocyanate/polyoxyalkylene polyol activator component; and
c) at least one of:
i) a diphenylmethane diisocyanate prepolymer component; or
iii) a diphenylmethane diisocyanate monomer component;
wherein when components a, b, and c are combined, a polyurethane reaction product is formed that is paintable in the absence of a primer and has a 100% modulus of less than about 100 psi in the absence of a plasticizer, and wherein diphenylmethane diisocyanate (calculated as monomer) is about 1% to 3% by weight of said reaction product.

38. The multicomponent formulation of claim 37, wherein the at least one of a diphenylmethane diisocyanate prepolymer component or a diphenylmethane diisocyanate monomer component is provided as a mixture with a hydroxy-terminated toluenediisocyanate/polyoxyalkylene polyol prepolymer component.

39. The multicomponent formulation of claim 37, wherein the at least one of a diphenylmethane diisocyanate prepolymer component or a diphenylmethane diisocyanate monomer component is provided as a mixture with an isocyanate-terminated toluenediisocyanate/polyoxyalkylene polyol activator component.

40. The multicomponent formulation of claim 37, wherein the polyoxyalkylene polyol of the hydroxy-terminated toluenediisocyanate/polyoxyalkylene polyol prepolymer component is selected from the group consisting of polyethylene ether glycol, polypropylene ether glycol, poly(tetramethylene ether)glycol, polyethers prepared by the copolymerization of cyclic ethers selected from the group consisting of ethylene oxide, propylene oxide, trimethylene oxide, tetrahydrofuran, and mixtures thereof, with aliphatic polyols selected from the group consisting of ethylene glycol, 1,3-butanediol, diethylene glycol, dipropylene glycol, 1,2-propylene glycol, 1,3-propylene glycol, and mixtures thereof, and combinations thereof.

41. The multicomponent formulation of claim 37, wherein the polyoxyalkylene polyol of the isocyanate-terminated toluenediisocyanate/polyoxyalkylene polyol activator component is selected from the group consisting of polyethylene ether glycol, polypropylene ether glycol, poly(tetramethylene ether)glycol, polyethers prepared by the copolymerization of cyclic ethers selected from the group consisting of ethylene oxide, propylene oxide, trimethylene oxide, tetrahydrofuran, and mixtures thereof, with aliphatic polyols selected from the group consisting of ethylene glycol, 1,3-butanediol, diethylene glycol, dipropylene glycol, 1,2-propylene glycol, 1,3-propylene glycol, and mixtures thereof, and combinations thereof.

42. The multicomponent formulation of claim 37, wherein the diphenylmethane diisocyanate prepolymer component additionally comprises an allophanate.

43. The multicomponent formulation of claim 37, wherein the diphenylmethane diisocyanate prepolymer component additionally comprises a polyoxyalkylene polyol.

44. The multicomponent formulation of claim 37, wherein the diphenylmethane diisocyanate prepolymer component is isocyanate-terminated.

45. The multicomponent formulation of claim 37, wherein the diphenylmethane diisocyanate prepolymer component is hydroxy-terminated.

46. The multicomponent formulation of claim 37, wherein the hydroxy-terminated toluenediisocyanate/polyoxyalkylene polyol prepolymer component has a number average molecular weight in the range of about 3,000 to about 20,000.

47. The multicomponent formulation of claim 37, wherein the hydroxy-terminated toluenediisocyanate/polyoxyalkylene polyol prepolymer component has a number average molecular weight in the range of about 6,000 to about 10,000.

48. The multicomponent formulation of claim 37, wherein the isocyanate-terminated toluenediisocyanate/polyoxyalkylene polyol activator component has a number average molecular weight in the range of about 1,000 to about 4,000.

49. The multicomponent formulation of claim 37, wherein the isocyanate-terminated toluenediisocyanate/polyoxyalkylene polyol activator component has a number average molecular weight in the range of about 1,500 to about 3,500.

50. The multicomponent formulation of claim 37, wherein the diphenylmethane diisocyanate component has a number average molecular weight in the range of about 250 to about 4,000.

51. The multicomponent formulation of claim 37, wherein the diphenylmethane diisocyanate component has a number average molecular weight in the range of about 250 to about 2,000.

52. The multicomponent formulation of claim 37, wherein the hydroxy-terminated toluenediisocyanate/polyoxyalkylene polyol prepolymer component comprises about 10% to about 92% by weight of the reaction product.

53. The multicomponent formulation of claim 37, wherein the hydroxy-terminated toluenediisocyanate/polyoxyalkylene polyol prepolymer component comprises about 20% to about 80% by weight of the reaction product.

54. The multicomponent formulation of claim 37, wherein the isocyanate-terminated toluenediisocyanate/polyoxyalkylene polyol activator component comprises about 1% to about 40% by weight of the reaction product.

55. The multicomponent formulation of claim 37, wherein the isocyanate-terminated toluenediisocyanate/polyoxyalkylene polyol activator component comprises about 5% to about 20% by weight of the reaction product.

56. The multicomponent formulation of claim 37, wherein the reaction product has a 100% modulus of about 40 psi to about 90 psi.

57. The multicomponent formulation of claim 37, wherein the mole ratio of isocyanate-terminated end groups to hydroxy-terminated end groups is about 0.5:1 to about 3:1.

58. The multicomponent formulation of claim 37, further comprising at least one component selected from the group consisting of UV absorbers, antioxidants, stabilizers, mildewcides, biocides, fungicides, fire or flame retardants, fillers, pigments, adhesion promoters, flow and leveling additives, wetting agents, antifoaming agents, rheology modifiers, and mixtures thereof.

59. The multicomponent formulation of claim 37, further comprising at least one UV stabilizer selected from the group consisting of 2-(2′-hydroxyphenyl)benzotriazoles, 2-hydroxybenzophenones, esters of substituted and unsubstituted benzoic acids, acrylates, nickel compounds, sterically hindered amines, oxanilides, 2-(2-hydroxyphenyl)-1,3,5-triazines, and mixtures thereof.

60. The multicomponent formulation of claim 37, further comprising at least one antioxidant selected from the group consisting of alkylated monophenols, alkylthiomethylphenols, hydroquinones and alkylated hydroquinones, tocopherols, hydroxylated thiodiphenyl ethers, alkylidenebisphenols, O-, N- and S-benzyl compounds, hydroxybenzylated malonates, aromatic hydroxybenzyl compounds, triazine compounds, benzylphosphonates, acylaminophenols, esters of beta-(3,5-di-tert-butyl-4-hydroxyphenyl)propionic acid with mono- or polyhydric alcohols, esters of beta-(5-tert-butyl-4-hydroxy-3-methylphenyl)propionic acid with mono- or polyhydric alcohols, esters of beta-(3,5-dicyclohexyl-4-hydroxyphenyl)propionic acid with mono- or polyhydric alcohols, esters of 3,5-di-tert-butyl-4-hydroxyphenyl acetic acid with mono- or polyhydric alcohols, amides of beta-(3,5-di-tert-butyl-4-hydroxyphenyl)propionic acid, ascorbic acid and derivatives, aminic antioxidants, and mixtures thereof.

61. The multicomponent formulation of claim 37, further comprising at least one fire or flame retardant selected from the group consisting of triphenyl phosphate, polyammonium phosphate, monoammonium phosphate, tri(2-chloroethyl) phosphate, melamine, exfoliated graphite, acid treated natural graphite flakes, and mixtures thereof.

62. The multicomponent formulation of claim 37, further comprising at least one filler selected from the group consisting of carbon black, titanium dioxide, zinc oxide, glass spheres, iron particles, quartz, hydrophilic silica, hydrophobic amorphous fumed silica, amorphous precipitated silica, barytes, limestone, sulfates, alumina, clays, diatomaceous earth, wollastonite, mica, perlite, flint powder, kryolite, talc, polymer granules, polymer powders, micronized polymers, melamine, zinc oxide, and mixtures thereof.

63. The polyurethane sealant of claim 37, further comprising at least one pigment selected from the group consisting of carbon black, titanium dioxide, barium sulfate, zinc oxide, zinc sulfide, basic lead carbonate, antimony trioxide, lithopones, iron oxides, graphite, luminescent pigments, zinc yellow, zinc green, ultramarine, manganese black, antimony black, manganese violet, Paris blue, Schweinfurter green, sepia, gamboge, Cassel brown, toluidine red, para red, Hansa yellow, indigo, azo dyes, anthraquinonoid and indigoid dyes, dioxazine, quinacridone, phthalocyanine, isoindolinone, and metal complex pigments, and mixtures thereof.

64. The multicomponent formulation of claim 37, further comprising at least one flow and leveling additive, wetting agent, or antifoaming agent selected from the group consisting of silicones, modified silicones, hydrocarbons, polyacrylates, fluorosurfactants, and mixtures thereof.

65. The multicomponent formulation of claim 37, further comprising at least one rheology modifier selected from the group consisting of fumed silica, hydroxyethyl cellulose, hydroxypropyl cellulose, and mixtures thereof.

66. The polyurethane sealant of claim 37, further comprising at least one adhesion promoter selected from the group consisting of
2-aminoethyl-dimethylmethoxysilane; 6-aminohexyl-tributoxysilane;
3-aminopropyl-trimethoxysilane; 3-aminopropyl-triethoxysilane;
3-aminopropyl-methyldiethoxysilane; 5-aminopentyl-trimethoxysilane;
5-aminopentyl-triethoxysilane and 3-aminopropyl-triisopropoxysilane,
γ-glycidoxypropyltrimethoxysilane, γ-glycidoxypropyltriethoxysilane,
γ-mercaptopropyltrimethoxysilane, γ-mercaptopropyltriethoxysilane, and,
γ-ureidopropyltrimethoxysilane, and γ-ureidopropyltriethoxysilane.

67. The polyurethane sealant of claim 37, wherein at least one component additionally comprises at least one chain extender selected from the group consisting of hydroxyl containing chain extenders and amine containing chain extenders.

68. The polyurethane sealant of claim 67, wherein said chain extender is selected from the group consisting of ethylene glycol, 1,3-propanediol, 2-methyl-1,3-propanediol, 1,4-butanediol, neopentyl glycol, diethylene glycol, ethylene diamine, 1,3-propanediamine, 1,4-butanediamine, 1,3-pentanediamine, 1,5-pentanediamine, 1,6-hexame diamine, 2-methylpentamethylenediamine, and mixtures thereof.

69. A method for making a sealant comprising:
a) providing a base component, an activator component, and a modifier component, wherein the base component comprises a hydroxy-terminated toluenediisocyanate/polyoxyalkylene polyol prepolymer, the activator component comprises an isocyanate-terminated toluenediisocyanate/polyoxyalkylene polyol activator, and the modifier component comprises at least one of a diphenylmethane diisocyanate prepolymer and a diphenylmethane diisocyanate monomer; and
b) combining the base component, activator component, and modifier component to form a polyurethane reaction product;
wherein the reaction product is paintable in the absence of a primer and has a 100% modulus of less than about 100 psi in the absence of a plasticizer, and wherein diphenylmethane diisocyanate (calculated as monomer) is about 1% to 3% by weight of said reaction product.

70. The method of claim 69, wherein the reaction product has a 100% modulus of about 40 psi to about 90 psi.

71. The method of claim 69, including combining the modifier component with the activator component prior to combination with the base component.

72. The method of claim 69, including combining the modifier component with the base component prior to combination with the activator component.

73. The method of claim 69, further comprising applying the reaction product to a substrate.

74. The method of claim 73, wherein said applying is selected from the group consisting of spraying, brushing, rolling, and combinations thereof.

75. The method of claim 73, wherein the substrate is selected from the group consisting of concrete, stone, metal, glass, plastic, wood, and composite materials.

76. The method of claim 69, further comprising applying paint to the sealant.

77. The method of claim 76, wherein the paint is selected from the group consisting of latex paint, solvent-borne paint, and solvent-free paint.

78. The method of claim 76, wherein the paint adheres to the surface of the sealant with a rating of at least 4B when tested according to the paint adhesion test ASTM D3359.
